(19) United States
(12) Patent Application Publication
(10) Pub. No.: US 2023/0130832 A1
(43) Pub. Date: Apr. 27, 2023

(54) HOT CHARGING SYSTEMS AND METHODS

(71) Applicant: Electric Power Systems, Inc., North Logan, UT (US)

(72) Inventor: Randy Dunn, Orange, CA (US)

(73) Assignee: Electric Power Systems, Inc., North Logan, UT (US)

(21) Appl. No.: 18/086,507

(22) Filed: Dec. 21, 2022

Related U.S. Application Data
(63) Continuation of application No. PCT/US2021/040012, filed on Jun. 30, 2021.
(60) Provisional application No. 63/047,594, filed on Jul. 2, 2020.

(51) Int. Cl. B60L 53/62; H01M 10/44; H01M 10/615; H02J 7/00; B60L 58/12; B60L 58/26; B60L 58/27; B60L 53/30

(52) U.S. Cl. CPC B60L 53/62; H01M 10/443; H01M 10/615; H02J 7/0048; H02J 7/00712; B60L 58/12; B60L 58/26; B60L 58/27; B60L 53/30; B60L 53/14

(57) ABSTRACT

A hot charging system for an electric vehicle may comprise a battery heating system, a battery cooling system, and a charging system. The hot charging system may be configured to heat a battery module while the battery module is charging and cool the battery module after the battery module is charged. The hot charging system may comprise a plumbing system and a control system. The plumbing system may be configured to place the battery heating system, the battery cooling system, and the battery module in fluid communication. The control system may be configured to charge the battery module via the charging system.

### CROSS-REFERENCE TO RELATED APPLICATIONS

This application is a continuation of, and claims priority to International Application No. PCT/US2021/040012, filed Jun. 30, 2021 and titled “HOT CHARGING SYSTEMS AND METHODS” (hereinafter the '012 Application). The '012 Application claims priority to, U.S. Provisional Application Ser. No. 63/047,594, filed Jul. 2, 2020, titled “HOT CHARGING SYSTEMS AND METHODS,” (hereinafter the '594 Application). The '012 Application and the '594 Application are hereby incorporated by reference in their entirety for all purposes.

### FIELD OF INVENTION

The present disclosure generally relates to apparatus, systems and methods for charging a battery module, in particular hot charging systems and methods for a battery module.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

A battery module, for purposes of this disclosure, includes a plurality of electrically connected cell-brick assemblies. These cell-brick assemblies may, in turn, include a parallel, series, or combination of both, collection of electrochemical or electrostatic cells hereafter referred to collectively as “cells”, that can be charged electrically to provide a static potential for power or release electrical charge when needed. When cells are assembled into a battery module, the cells are often linked together through metal strips, straps, wires, bus bars, etc., that are welded, soldered, or otherwise fastened to each cell to link them together in the desired configuration.

A cell may be comprised of at least one positive electrode and at least one negative electrode. One common form of such a cell is the well-known secondary cells packaged in a cylindrical metal can, in a pouch, or in a prismatic case. Examples of chemistry used in such secondary cells are lithium cobalt oxide, lithium manganese, lithium iron phosphate, nickel cadmium, nickel zinc, and nickel metal hydride. Such cells are mass produced, driven by an ever-increasing consumer market that demands low cost rechargeable energy for portable electronics. Moreover, a cell may comprise any suitable form and chemistry.

Charging a battery module for an electric vehicle, such as an aircraft, a drone, or a car, typically may take anywhere from 30 minutes to 12 hours. In order to improve a charge time, a battery module may receive a massive influx of electrons during charging. However, typical battery modules are not equipped to handle such a massive influx of electrons during charging. As such, improved charging systems and methods may be desirable.

### SUMMARY OF THE INVENTION

A method of fast charging a battery module is disclosed herein. The method may comprise: heating, via a battery heating system, the battery module; charging, via a charging system, the battery module while the battery module is heated; and subsequently cooling, via a battery cooling system, the battery module.

In various embodiments, heating the battery module further comprises pumping a first fluid through the battery module via the battery heating system. Cooling the battery module may further comprise pumping a second fluid through the battery module via the battery cooling system. The first fluid may be routed through a fluid conduit in fluid communication with the battery module, and the second fluid may be routed through the fluid conduit in fluid communication with the battery module. The charging system may comprise a charger in electrical communication with the battery module via electrical wires, and the electrical wires may be routed through the fluid conduit. The first fluid may be between 40° C. and 100° C. during heating the battery module, and the second fluid may be between −10° C. and 20° C. during cooling the battery module. The method may further comprise monitoring, via a battery management system, a state of charge of the battery module during charging the battery module.

A hot charging system for use on an electric vehicle is disclosed herein. The hot charging system may comprise: a battery heating system configured for fluid communication with a battery module of the electric vehicle; a battery cooling system configured for fluid communication with the battery module of the electric vehicle; a charger configured for electrical communication with the battery module of the electric vehicle; a controller in electric communication with the battery heating system and the battery cooling system; and a fluid conduit configured to removably couple to the electric vehicle, the fluid conduit comprising electrical wires therein, the fluid conduit configured to receive a first fluid from the battery heating system, the fluid conduit configured to receive a second fluid from the battery cooling system, the electrical wires electrically isolated from the first fluid and the second fluid.

In various embodiments, the battery heating system comprises a hot tank and a first feed pump, and wherein the battery cooling system comprises a cold tank and a second feed pump. The first feed pump may be configured to pump fluid from the hot tank through the fluid conduit to heat the battery module during charging of the battery module. The hot charging system may further comprise a climate control system including a third feed pump and a fourth feed pump, the third feed pump in fluid communication with the hot tank, the fourth feed pump in fluid communication with the cold tank. The climate control system may be configured to pump fluid to a climate control device of the electric vehicle through the fluid conduit. The controller may be operable to: command the battery heating system to pump the first fluid through the fluid conduit to heat the battery module; command the charger to charge the battery module; and command the battery cooling system to pump the second fluid through the fluid conduit to cool the battery module. The controller may be further operable to: command a heating system of the battery heating system to heat the first fluid prior to pumping the first fluid; and command a cooling system of the battery cooling system to cool the second fluid prior to pumping the second fluid.

An article of manufacture is disclosed herein. The article of manufacture may include a tangible, non-transitory computer-readable storage medium having instructions stored thereon that, in response to execution by a processor, cause the processor to perform operations comprising: commanding, by the processor, a first feed pump to pump a first fluid through a battery module, the first fluid being heated to a first temperature between 40° C. and 100° C.; commanding, by the processor, a charger to charge the battery module; and commanding, by the processor, a second feed pump to pump a second fluid through the battery module, the second fluid having a second temperature less than the first fluid.

In various embodiments, the operations may further comprise: commanding, by the processor, a heating system to heat the first fluid to the first temperature prior to pumping the first fluid; and commanding, by the processor, a cooling system to cool the second fluid to the second temperature prior to pumping the second fluid. The operations may further comprise receiving, by the processor, a state of charge of the battery module while the battery module is charging. The first feed pump may pump the first fluid through a fluid conduit disposed between a ground service system and a vehicle with the battery module. The second feed pump may pump the second fluid through the fluid conduit when the second fluid is being pumped through the battery module. The operations may further comprise commanding, by the processor, the charger to stop charging in response to the battery module reaching a predetermined state of charge; and subsequently commanding the second feed pump to pump the second fluid.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and where:

FIG. 1 illustrates a method of hot charging a battery module for an electric vehicle, in accordance with various embodiments;

FIG. 2 illustrates a hot charging system for an electric vehicle, in accordance with various embodiments;

FIG. 3 illustrates a hot charging system for an electric vehicle, in accordance with various embodiments;

FIG. 4 illustrates a process flow for a control system for hot charging a battery module for an electric vehicle, in accordance with various embodiments;

FIG. 5 illustrates a hot charging system with a climate control system for an electric vehicle, in accordance with various embodiments;

FIG. 6 illustrates a hot charging system with a climate control system for an electric vehicle, in accordance with various embodiments;

FIG. 7A illustrates fluid conduit for use in a hot charging system for an electric vehicle, in accordance with various embodiments; and

FIG. 7B illustrates fluid conduit for use in a hot charging system for an electric vehicle, in accordance with various embodiments.

### DETAILED DESCRIPTION

The following description is of various example embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims. For example, the steps recited in any of the method or process descriptions may be executed in any order and are not necessarily limited to the order presented. Moreover, many of the manufacturing functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. As used herein, the terms “coupled,” “coupling,” or any other variation thereof, are intended to cover a physical connection, an electrical connection, a magnetic connection, an optical connection, a communicative connection, a functional connection, and/or any other connection.

Typical fast charging systems may result in lithium plating on an anode of each cell in a battery module. As the current (or the rate of flow of charge) increases, more lithium ions plate the electrode, ultimately resulting in a drastic reduction in capacity of the battery module due to charging at very high charging rates. Thus, typical fast charging systems increase a rate of aging for a battery module, the cell capacity may be dominated by lithium-inventory loss, and gas evolution and lithium plating limit fast charging capability.

Disclosed herein is a hot charging system for use in an electric vehicle, such as an electric automobile, electric airplane or drone, or any electric device where fast charging is desirable. In various embodiments, the hot charging system is a fast charging system. In various embodiments, the hot charging system may heat up the battery module during the charging process with a fluid having a temperature between 40° C. and 100° C., or more preferably approximately 60° C. In various embodiments, the battery module is heated with a fluid having a temperature at approximately 60° C. to increase lithium graphite intercalation of cells in a battery module by approximately 13 times that of typical fast charging systems and significantly reduce lithium plating. In various embodiments, the heating of the battery module with a fluid at a temperature as disclosed herein may increase a rate at which the lithium diffuses into the graphite. The rate at which the lithium diffuses into the graphite is increased approximately 6 times in typical fast charging systems. In various embodiments, the heating of the battery module with a fluid at a temperature as disclosed herein may increase an electrolyte conductivity by approximately 9 times relative to typical fast charging systems.

In various embodiments, heating the battery module may cause a layer of solid electrolyte interphase growth within cells in the battery module when the cells in the battery module remain heated for too long. Therefore, in accordance with an example embodiment, the battery management system is configured to cool the battery module to limit the growth of the solid electrolyte interphase layer. For example, the battery management system may be configured to cool the battery after charging is completed. In another example embodiment, the battery management system may be configured to cool the battery after a predetermined amount of time charging, at a predetermined state of charge, after a predetermined amount of power has been transferred to the battery module, after a period of time at a particular temperature, after current begins to decline (e.g., less of a lithium plating threat would likely exist), and/or the like. Furthermore, battery modules in electric vehicles may be in a hot environment after use, so a battery module may be unable to cool naturally after hot charging, in accordance with various embodiments. In this regard, in accordance with various embodiments, cooling the battery module after charging may enhance the battery life of the battery module.

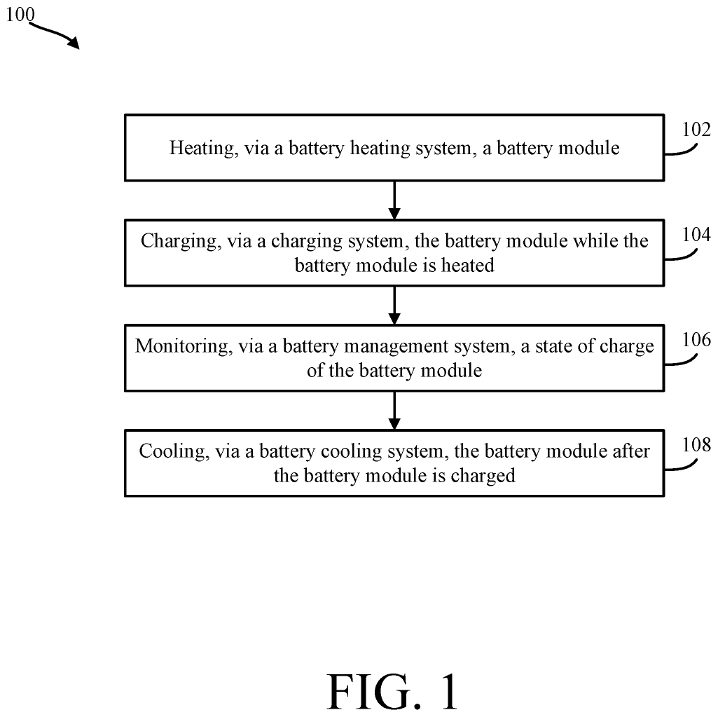

Referring now to FIG. 1, a method 100 for hot-charging a battery module, in accordance with various embodiments, is illustrated. The method comprises heating, via a battery heating system, a battery module (step 102). In various embodiments, the battery module may be heated with a fluid having a temperature between 40° C. and 100° C., or more preferably approximately 60° C. In various embodiments, the battery heating system may be any system configurable to heat the battery module during charging, as described further herein. In various embodiments, the heating system may utilize plumbing or the like to supply a hot fluid proximate to a plurality of cells in the battery module. For example, the battery heating system may include a tank filled with a hot fluid. The tank may be in fluid communication with the battery module via a plumbing system. The plumbing system may cycle the fluid through the battery module and back to the tank during heating of the module. In an example embodiment, upon completion of the heating and/or charging of the battery module, the heating fluid may be pumped back to the tank. In various embodiments, the heating fluid may be returned to the tank by any method, such as gravity, air pressure, pumping, or the like. In another example embodiment, the fluid flows continuously in a loop out of the tank, through the module, and back into the tank. In various example embodiments, the fluid is heated while in the tank. In other example embodiments, the fluid is heated before being added to the tank. In yet another example embodiment, the fluid is heated as it is needed. Thus, in one example embodiment, the system is tank-less.

In various embodiments, the method 100 further comprises charging, via a charging system, the battery module while the battery module is heated (step 104). In various embodiments, the charging system is in electrical communication with the battery module. In various embodiments, the battery module is charged simultaneously with a heating step (e.g., step 106). In various embodiments, the battery module is heated and then charged.

In various embodiments, wires of the charging system may be disposed through the plumbing system of the battery heating system. In this regard, by electrically coupling a charger to the battery module, the plumbing system of the battery heating system may become in fluid communication with the battery module, and the charger of the charging system may be in electrical communication with the battery module. The electrical wires are electrically isolated from the hot fluid in the battery heating system.

In various embodiments, the charging may be for a short time duration. For example, the time duration of the charging may be between 5 minutes and 15 minutes, or between 6 minutes and 12 minutes, or approximately 10 minutes. In various embodiments, the heating may be stopped in response to the battery module reaching a certain physical condition (e.g., a state of charge between 70% and 100% or the like). In various embodiments, the flow of heating fluid to the battery may be stopped (or may begin to decrease) in response to a drop in the current being supplied to the battery module (e.g., the rate of charging beginning to decrease). In another example embodiment, the heating and cooling system(s) can be configured to reduce the temperature of the battery in proportion to the decrease in the current flow to the battery or in proportion to the decrease in the charging rate of the battery.

In various embodiments, the method 100 further comprises monitoring, via a battery management system, a state of charge of the battery module (step 106). The battery management system may be in electrical communication with the battery module and a controller. The battery management system may provide a signal to the controller indicating a charge is complete. In response to the signal from the battery management system in accordance with various embodiments, the controller may (1) instruct the charger to stop charging the battery module, (2) instruct the battery heating system to stop heating the battery module, and/or (3) instruct a cooling system to start cooling the battery module.

In various embodiments, the method 100 may further comprise cooling, via a battery cooling system, the battery module after the battery module is charged (step 108). In this regard, once the battery module has reached a particular state of charge, the battery module may be actively cooled after hot charging to prevent a layer of solid electrolyte interphase growth within cells in the battery module. Cooling after hot charging, as described herein, may provide an additional benefit to aeronautical battery applications, where the battery module may still be in a hot environment after hot charging, so the battery module may not cool naturally (i.e., passively) after the hot charging, in accordance with various embodiments.

In various embodiments, the cooling may begin prior to the battery module reaching 100% state of charge. The disclosure is not limited in this regard. In an example embodiment, the cooling may be triggered at a state of charge between 70% and 100% charged, or more preferably between 80% and 90% charged. Moreover, any suitable state of charge may be used as a trigger to stop heating and/or start cooling the battery. In various embodiments, the cooling may be triggered in response to a drop in current as disclosed previously herein. In various embodiments, a drop in current to the battery may be detected by temperature sensors in the battery module, timers, a state of charge in a predetermined range, or any other method of determining a drop in current to the battery during charging of the battery.

The battery cooling system may comprise any system configured to cool the battery module. For example, the battery cooling system may comprise a plumbing system with a fluid configured to cool the battery module, such as water, air, or the like. The battery module may be electrically isolated from the plumbing system. The plumbing system may cool the system via convection, conduction, or a combination of the two.

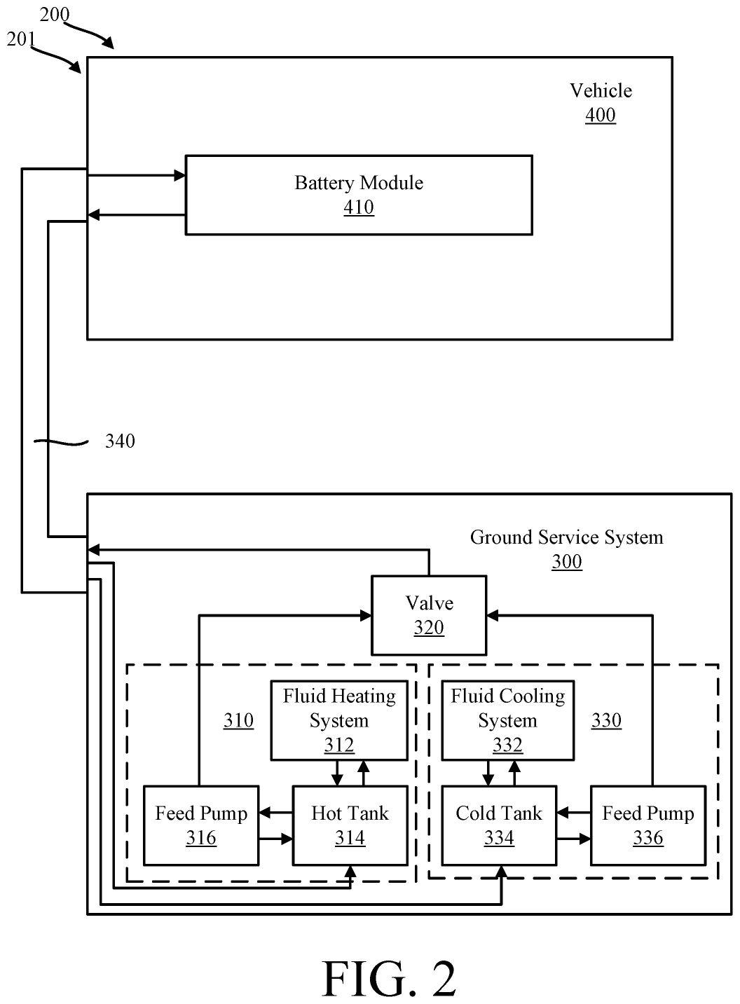

Referring now to FIG. 2, a schematic view of a hot charging system 200 for hot charging a battery module 410 in accordance with the method 100 from FIG. 1 is illustrated, in accordance with various embodiments. The hot charging system 200 may comprise a plumbing system 201, in accordance with various embodiments. The plumbing system 201 may comprise a battery heating system 310 and a battery cooling system 330. The battery heating system 310 may be any system configured to heat a battery module (e.g., battery module 410) of a vehicle (e.g., vehicle 400). The vehicle 400 may be any vehicle comprising a battery module 410, such as an electric car, an electric aircraft, an electric drone, or any other electric vehicle known in the art. In various embodiments, the vehicle 400 may comprise any vehicle with a battery that may benefit from rapid charging as disclosed herein. In various embodiments, the rapid charging as disclosed herein may be applied to a stationary or grid connected application. For example, this disclosure is not limited to vehicles, and may be utilized in a grid service where the battery modules are always connected but may utilize rapid charging at times.

Although described herein with a plumbing system 201, any system configured to heat and cool a battery module 410 is within the scope of this disclosure. For example, battery heating system 310 may comprise a heating system using electric heating, such as via radiant heaters, convection heaters, or the like, and is within the scope of this disclosure. Similarly, battery cooling system 330 may comprise any cooling system configured to cool the battery module 410 after hot charging the battery module 410 in accordance with method 100 (e.g., step 108). In various embodiments, the heating may be over a time of about five to ten minutes. In an example embodiment, a change in the charging rate may be proportional to an increase in the temperature of the battery. The change in charging rate is proportional to the change in the current supplied to the battery (e.g., the battery module charges faster as current is increased).

In various embodiments, the battery heating system 310 may comprise a fluid heating system 312, a hot tank 314, a feed pump 316, a valve 320, a fluid conduit 340, and various fluid lines allowing fluid communications between each component in the battery heating system 310. In various embodiments, the fluid heating system 312 may comprise any heating system configured to heat up a tank of fluid (e.g., hot tank 314). In various embodiments, the fluid heating system 312 may comprise any hydronic system, such as a boiler using natural gas, oil, or steam for fuel. In various embodiments, the fluid heating system 312 may comprise an electric heating system, such as radiant heaters or convection heaters, or preferably resistive electrical elements. The fluid heating system 312 may be configured to heat a fluid in the hot tank 314 to a regulated temperature (e.g., approximately 60° C., or the like). The fluid heating system 312 may comprise a temperature sensor in electric communication with a controller to provide continuous feedback to a temperature of a fluid disposed in the hot tank 314.

In various embodiments, the hot tank 314 is in fluid communication with a feed pump 316. The feed pump 316 may be configured to supply the fluid disposed in the hot tank 314 to battery module 410 during a battery heating step of method 100 from FIG. 1 (e.g., step 102 of method 100), in accordance with various embodiments. In various embodiments, the feed pump 316 is in fluid communication with a valve 320. The valve 320 may be a one way valve to ensure only a fluid from the battery heating system 310 or a fluid from the battery cooling system 330 is being supplied to battery module 410. Although illustrated as comprising valve 320, the battery heating system 310 and the battery cooling system 330 may comprise separate fluid supply lines and return lines to the battery module 410, in accordance with various embodiments, and still be within the scope of this disclosure. In accordance with various embodiments, the valve 320 may provide an advantage of having fewer parts and fewer fluid lines for a plumbing system 201 of hot charging system 200 relative to a system with independent lines.

In various embodiments, the battery cooling system 330 may comprise a fluid cooling system 332, a cold tank 334, a feed pump 336, valve 320, a fluid conduit 340, and various fluid lines allowing fluid communications between each component in the battery cooling system 330. In various embodiments, the fluid cooling system 332 may comprise any cooling system configured to cool a tank of fluid (e.g., cold tank 334). In various embodiments, the fluid cooling system 332 may comprise any fluid cooling system, such as a liquid-liquid cooling system, a closed-loop dry cooling system, an open-loop evaporative cooling system, a closed-loop evaporative cooling system, a chilled water cooling system, a forced air radiator cooling system, or preferably a chilled water system having an environmentally friendly refrigeration system. The fluid cooling system 332 may be configured to cool a fluid in the cold tank 334 to a regulated temperature (e.g., below 40° C., or more preferably approximately 0° C., or the like). The fluid cooling system 332 may comprise a temperature sensor in electric communication with a controller to provide continuous feedback to a temperature of a fluid disposed in the cold tank 334.

In various embodiments, the cold tank 334 is in fluid communication with a feed pump 336. The feed pump 336 may be configured to supply the fluid disposed in the cold tank 334 to battery module 410, in accordance with various embodiments, during a battery cooling step of method 100 from FIG. 1 (e.g., step 108 of method 100). In various embodiments, the feed pump 336 is in fluid communication with a valve 320. In various embodiments, the valve 320 is in fluid communication with the fluid conduit 340. The fluid conduit 340 may be removably coupled to the vehicle 400. In this regard, when the battery module 410 of vehicle 400 is to be charged, the fluid conduit 340 may be coupled to vehicle 400 and provide fluid communication between the fluid conduit 340 and the battery module 410. Similarly, the fluid conduit 340 may be configured to house electrical components of a charging system as further described herein. In this regard, the electrical components may provide electrical communication between the ground service system 300 and the vehicle 400, in accordance with various embodiments. Although illustrated as a single fluid conduit 340, in various embodiments, an electrical conduit (e.g., a wiring harness), and a fluid conduit (e.g., a pipe) may be utilized separately to provide electrical and fluid connections between the ground service system 300 and the vehicle 400.

In various embodiments, the fluid conduit 340 may comprise a supply line configured to be in fluid communication with valve 320 and at least one return line configured to be in fluid communication with the hot tank 314 and the cold tank 334. In this regard, during a heating step of battery module 410 (e.g., step 102 of method 100 from FIG. 1), the feed pump 316 pumps a fluid from hot tank 314 through the valve 320 through the fluid conduit 340 via a supply line, through battery module 410, back through a return line through fluid conduit 340, and back into the hot tank 314. In various embodiments, a valve may be disposed along the return line configured to route the fluid back to the hot tank 314 during heating of the battery module (e.g., step 102 of method 100 from FIG. 1). Similarly, during a cooling step of a battery module 410 (e.g., step 108 of method 100), the feed pump 336 pumps a fluid from cold tank 334 through the valve 320 through the fluid conduit 340 via a supply line, through battery module 410, back through a return line through fluid conduit 340, and back into the cold tank 334. In various embodiments, a valve may be disposed along the return line configured to route the fluid back to the cold tank 334 during cooling of the battery module (e.g., step 108 of method 100).

In various embodiments, the battery heating system 310 and the battery cooling system 330 may be sealed systems (e.g., a closed system). In various embodiments, the battery heating system 310 and the battery cooling system 330 may include solenoid valves to direct return instead of using a sealed system. In various embodiments, any return system known in the art may be utilized for plumbing system 201.

In various embodiments, battery heating system 310 and battery cooling system 330 may utilize air as the heat transfer fluid. In this regard, the electrical wires disposed in the fluid conduit 340 would not have to be fluidly isolated from the heat transfer fluid.

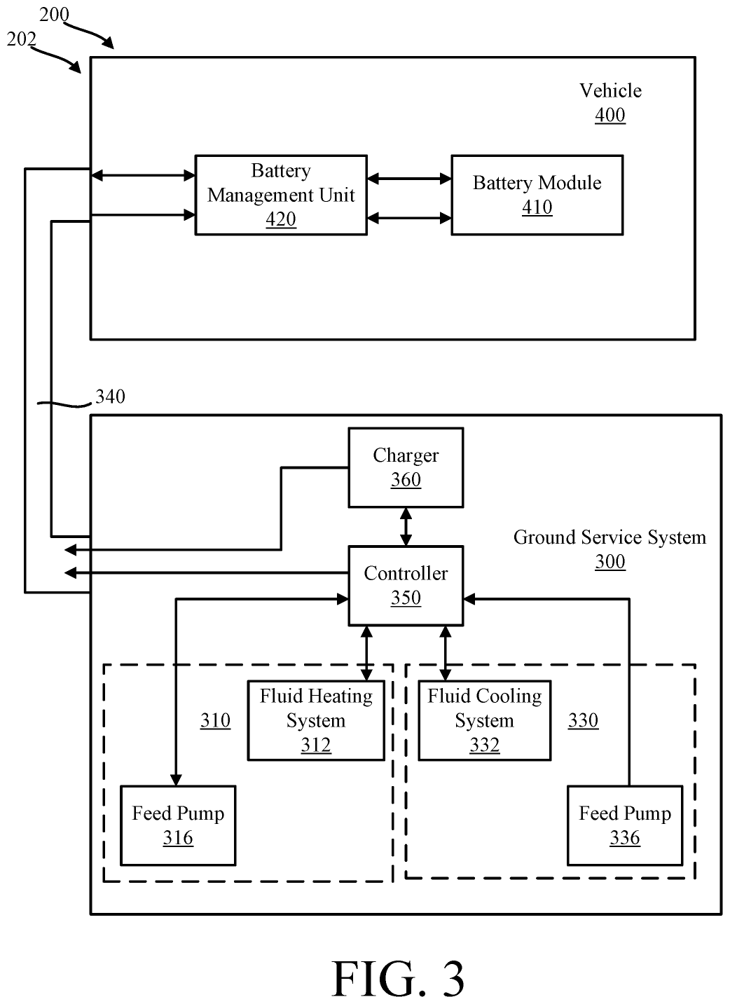

Referring now to FIG. 3, a schematic view for a control system 202 of a hot charging system 200 for an electric vehicle (e.g., vehicle 400) is illustrated, in accordance with various embodiments. Control system 202 includes a controller 350, a charger 360, the battery heating system 310, and the battery cooling system 330 of ground service system 300 and a battery management unit (“BMU”) 420 and the battery module 410 of the vehicle 400, each component in various electrical communication.

Controller 350 may comprise at least one computing device in the form of a computer or processor, or a set of computers/processors, although other types of computing units or systems may be used. In various embodiments, controller 350 may be implemented as and may include one or more processors and/or one or more tangible, non-transitory memories and be capable of implementing logic. Each processor may be a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof. Controller 350 may comprise a processor configured to implement various logical operations in response to execution of instructions, for example, instructions stored on a non-transitory, tangible, computer-readable medium configured to communicate with controller 350. In various embodiments, controller 350 may be integrated into computer systems onboard ground service system 300. In various embodiments, controller 350 may be integrated with sensors.

BMU 420 may comprise at least one computing device in the form of a computer or processor, or a set of computers/processors, although other types of computing units or systems may be used. In various embodiments, BMU 420 may be implemented as and may include one or more processors and/or one or more tangible, non-transitory memories and be capable of implementing logic. Each processor may be a general purpose processor, a DSP, an ASIC, a FPGA or other programmable logic device, discrete gate or transistor logic, discrete hardware components, or any combination thereof. BMU 420 may comprise a processor configured to implement various logical operations in response to execution of instructions, for example, instructions stored on a non-transitory, tangible, computer-readable medium configured to communicate with BMU 420. In various embodiments, BMU 420 may be integrated into computer systems onboard an electric vehicle (e.g., vehicle 400), such as, for example, a battery control system. In various embodiments, BMU 420 may be integrated with sensors.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Controller 350 may be in electrical communication with the feed pump 316 and the fluid heating system 312 of battery heating system 310, the fluid cooling system 332, and the feed pump 336 of battery cooling system 330, the charger 360, and the BMU 420. The BMU 420 may be in electrical communication with the battery module 410, the controller 350, and the charger 360. In various embodiments, the controller 350 and/or the BMU 420 may control the hot charging system 200. In various embodiments, the BMU 420 may be configured to monitor the battery module 410 during fast charging of the battery module 410 (e.g., step 106 of method 100). In this regard, the BMU 420 may monitor when the battery module 410 has reached a predetermined state of charge and instruct the controller 350 to turn off the battery heating system 310 and turn on the battery cooling system 330. Additionally, in accordance with various embodiments, the controller 350 may instruct the charger 360 to stop charging the battery module 410 after the battery module 410 reaches a particular state of charge. In various embodiments, hot charging system 200 may be controlled by BMU 420, or more preferably by controller 350 of ground service system 300.

In various embodiments, the electrical connections between the BMU 420 and the controller 350 and between the BMU 420 and the charger 360 may be routed through the fluid conduit 340 and electrically isolated from any fluid traveling through the fluid conduit 340. In this regard, by coupling fluid conduit 340 to vehicle 400, the BMU 420 may be electrically coupled to the ground service system 300, and the battery module 410 may be fluidly coupled to the plumbing system 201 from FIG. 2. In various embodiments, the BMU 420 may control its own set of switches for safety to protect the battery module 410. In various embodiments, battery charge operations may be handled by the ground service system 300 (e.g., via controller 350). As such, the fluid conduit 340 may perform a dual function (e.g., routing heated and cooled fluid to the battery module for heating and cooling in steps 104 and 108 of method 100, and electrically coupling the ground service system 300 to the BMU 420 of the vehicle 400).

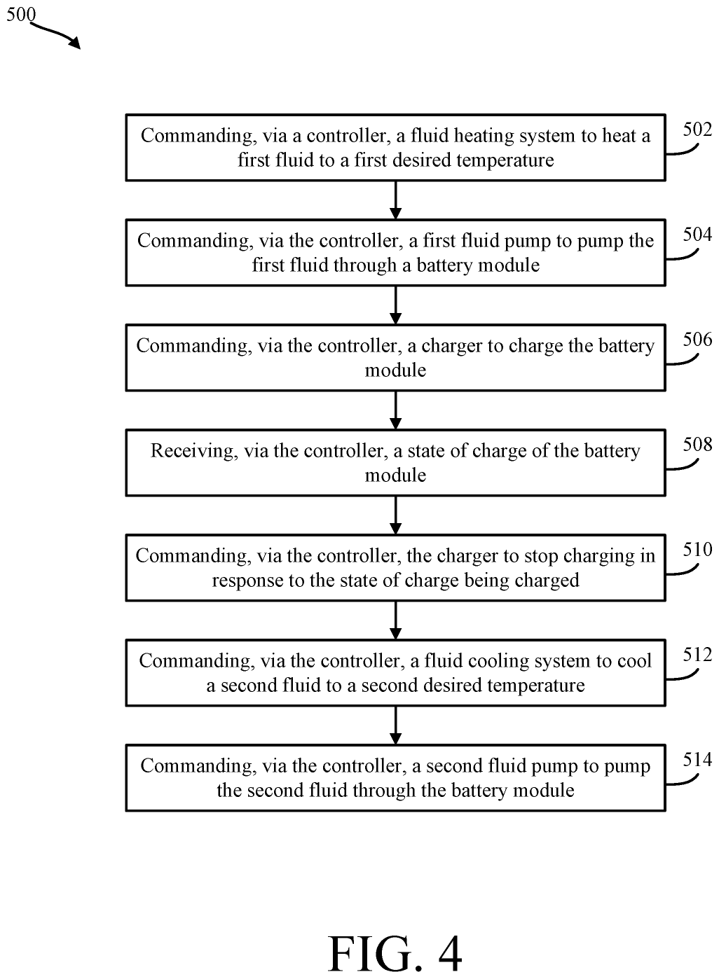

In various embodiments and with additional reference to FIG. 4, a process flow 500 for a controller 350 from FIG. 3 is illustrated, in accordance with various embodiments. In various embodiments, the controller 350 commands the fluid heating system 312 of the battery heating system 310 to heat a first fluid to a first desired temperature (step 502). The first fluid may be any heat transfer fluid, such as oil, synthetic hydrocarbon or silicon based fluids, water vapor, nitrogen, argon, helium, hydrogen, or preferably water. The first desired temperature may be between 40° C. and 100° C., or more preferably approximately 60° C. The first fluid may be heated in a hot tank (e.g., hot tank 314 from FIG. 2). The controller 350 may regulate the temperature of the first fluid in the hot tank. For example, the controller 350 may receive information from a sensor in the hot tank and use the data to increase or decrease heat supplied by the fluid heating system 312, in accordance with various embodiments.

In various embodiments, the controller 350 commands a first feed pump (e.g., feed pump 316) to pump the first fluid through a battery module 410. The battery module 410 may be disposed on an electric vehicle (e.g., vehicle 400), and the controller 350, the feed pump 316, the fluid heating system 312, and the hot tank (e.g., hot tank 314 from FIG. 2) may be components of a ground service system 300. The feed pump 316 may be in fluid communication with the battery module through a plumbing system (e.g., plumbing system 201 from FIG. 2). In response to pumping the first fluid through the plumbing system, cells in the battery module may increase in temperature to a temperature proximate the desired temperature of the first fluid. For example, the cells in the battery module 410 may heat up the first fluid to a temperature between approximately 40° C. and 80° C., in accordance with various embodiments.

In various embodiments, the system is configured to elevate a temperature of the cells in the battery module 410 such that the cells in the battery module may be charged at a faster rate than typical charging systems. In various embodiments, the BMU 420 may monitor a temperature of the cells during the heating process. The BMU 420 may communicate this data to the controller 350. In this regard, the controller 350 may command the charger 360 to begin charging in response to the cells reaching a desired temperature as described further herein. In various embodiments, heating and charging may begin simultaneously, or near simultaneously. In an example embodiment, a heated fluid is supplied to heat the cells quickly. However, in accordance with various embodiments, the charging of the cells may augment the heating of the cells (e.g., help heat the battery module faster). Moreover, electrical resistive heating may be used to add further heat to the cells. These latter two examples, however, may be insufficient to heat the cells quickly enough, and to subsequently cool the system quickly enough for improved speed of charging the battery. Thus, the system may be designed to heat the cells through a combination of providing a heating fluid to the cells, resistive heating, and/or through heating associated with the act itself of charging of the cells.

In accordance with various embodiments, once the cells reach the desired temperature, a charging step may begin. In various embodiments, a charging step may occur simultaneously with the heating step (e.g., step 504 of process flow 500). In this regard, the rate of charging can increase following the temperature increase of the battery. Thus, the battery can be charged as quickly as the temperature increase makes possible.

The system may further be configured to determine when to stop heating the battery and/or start cooling the battery. In an example embodiment, the current flowing to the battery will increase following the heating of the battery, but will cease increasing as the battery nears a fully charged state. Thus, in one example embodiment, the stopping of heating and/or starting of cooling of the battery may be triggered by an inflection from increasing current to decreasing current supplied to the battery. Moreover, any suitable trigger may be used to cause the system to cease heating and/or start cooling the battery.

In various embodiments, the controller 350 commands the charger 360 to charge the battery module 410 (step 506). In various embodiments, the charger 360 may utilize direct current charging (e.g., DC charging). The direct current may be supplied through the BMU 420 or directly to the battery module 410. DC charging may provide faster charging than typical alternating current charging (e.g., AC charging). In this regard, the DC charging of the charger 360 may allow the battery module 410 to charge at a faster rate (e.g., 6 C to 3 C) without any additional degradation relative to a typical charging system having a typical charging rate (e.g., 1 C to C/2), in accordance with various embodiments.

In various embodiments, the controller 350 may monitor a state of charge of the battery module 410 (step 508). In various embodiments, the BMU 420 may monitor the state of charge of the battery module 410 and communicate this information to the controller 350. In various embodiments, the controller 350 commands the charger 360 to stop charging in response to the battery module 410 reaching a predetermined state of charge (step 510). A predetermined state of charge, as described herein, is between 70% and 100% charged, or more preferably between 80% and 90% charged.

In various embodiments, the controller 350 commands the cooling system to cool a second fluid to a second desired temperature. The second fluid may be any heat transfer fluid, such as oil, synthetic hydrocarbon or silicon based fluids, water vapor, nitrogen, argon, helium, hydrogen, glycol, or preferably water. The second desired temperature may be between −5° C. and 10° C., or more preferably approximately 0° C. The second fluid may be cooled in a cold tank (e.g., cold tank 334 from FIG. 2). The controller 350 may regulate the temperature of the second fluid in the cold tank. For example, the controller 350 may receive information from a sensor in the cold tank and use the data to increase or decrease heat supplied by the fluid cooling system 332, in accordance with various embodiments.

In various embodiments, the controller 350 commands the second feed pump (e.g., feed pump 336) to pump the second fluid through the battery module 410 (step 514). In response to pumping the second fluid through the plumbing system, cells in the battery module 410 may decrease in temperature to a temperature proximate to the desired temperature of the second fluid. For example, the cells in the battery module 410 may cool down to a temperature that is between approximately 0° C. and 20° C., in accordance with various embodiments.

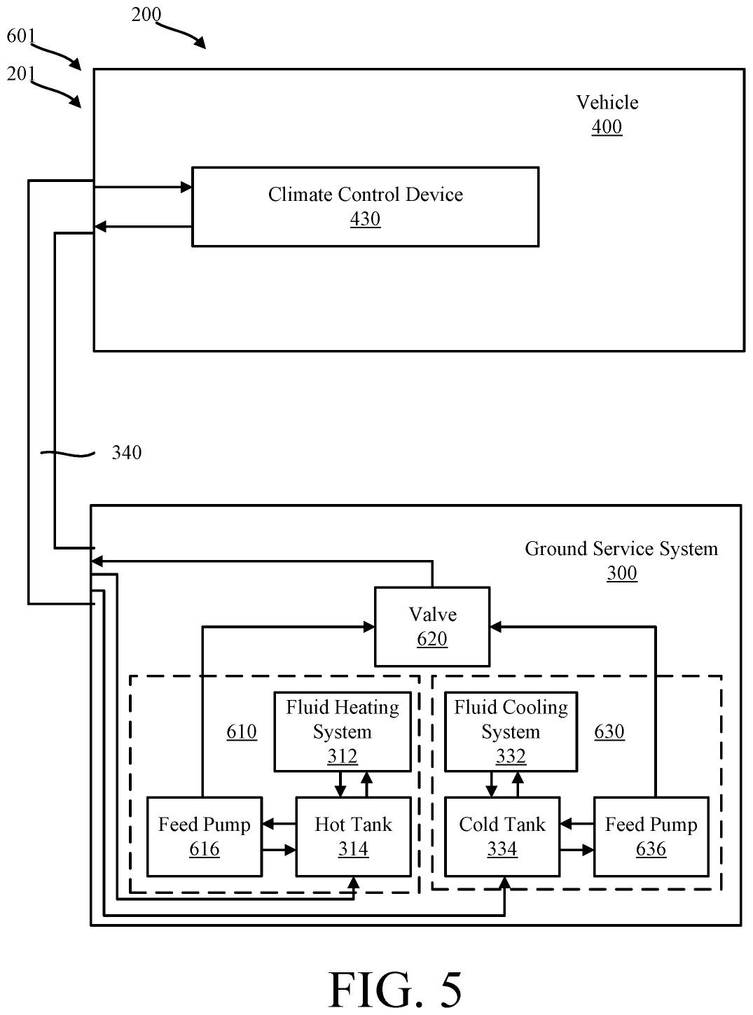

In various embodiments, with reference now to FIG. 5, a climate control system 601 may be implemented in a hot charging system 200 for an electric vehicle (e.g., vehicle 400) without significantly adding mass to the vehicle (e.g., vehicle 400). In this regard, the vehicle 400 may further comprise a climate control device 430. The climate control device 430 may be any climate control device for a cabin of an aircraft, or the like. For example, the climate control device 430 may comprise a radiator and a fan, or any other climate control device known in the art.

In various embodiments, the climate control system 601 may further comprise a climate heating system 610 and a climate cooling system 630. The climate heating system 610 and the climate cooling system 630 may be components of the ground service system 300. The climate heating system 610 may comprise the fluid heating system 312, the hot tank 314, and a feed pump 616. Similarly, the climate cooling system 630 may comprise the fluid cooling system 332, the cold tank 334, and a feed pump 636. In various embodiments, the feed pump 616 may be a discrete component from feed pump 316 of the battery heating system 310 from FIG. 2. Similarly, the feed pump 636 may be a discrete component from the feed pump 336 of the battery cooling system 330 from FIG. 2.

In various embodiments, the hot tank 314 is in fluid communication with the feed pump 616. The feed pump 616 may be configured to supply the fluid disposed in the hot tank 314 to climate control device 430, in accordance with various embodiments, during a method of controlling a cabin climate as described further herein. In various embodiments, the feed pump 616 is in fluid communication with a valve 620. The valve 620 may be a one way valve to ensure only a fluid from the climate heating system 610 or a fluid from the climate cooling system 630 is being supplied to climate control device 430. Although illustrated as comprising valve 620, the climate heating system 610 and the climate cooling system 630 may comprise separate fluid supply lines and return lines to the climate control device 430, in accordance with various embodiments, and still be within the scope of this disclosure. In accordance with various embodiments, the valve 620 may provide an advantage of having fewer parts and fewer fluid lines for a plumbing system 201 of climate control system 601. In various embodiments, the valve 620 may be a discrete component from the valve 320 from FIG. 2.

In various embodiments, the valve 620 is in fluid communication with the fluid conduit 340. The fluid conduit 340 may be removably coupled to the vehicle 400. In this regard, when the battery module 410 of vehicle 400 from FIG. 2 is to be charged, the fluid conduit 340 may be coupled to vehicle 400 and provide fluid communication between the fluid conduit 340 and the battery module 410, as well as providing fluid communication between the fluid conduit 340 and the climate control device 430.

In various embodiments, the fluid conduit 340 may comprise a supply line configured to be in fluid communication with valve 620 and at least one return line configured to be in fluid communication with the hot tank 314 and the cold tank 334. In this regard, while supplying a hot fluid from hot tank 314 to the climate control device 430, the feed pump 616 pumps a fluid from hot tank 314 through the valve 620 through the fluid conduit 340 via a supply line, through climate control device 430, back through a return line through fluid conduit 340, and back into the hot tank 314. Similarly, while supplying a cold fluid from cold tank 334 to the climate control device 430, the feed pump 636 pumps a fluid from cold tank 334 through the valve 620 through the fluid conduit 340 via a supply line, through climate control device 430, back through a return line through fluid conduit 340, and back into the cold tank 334.

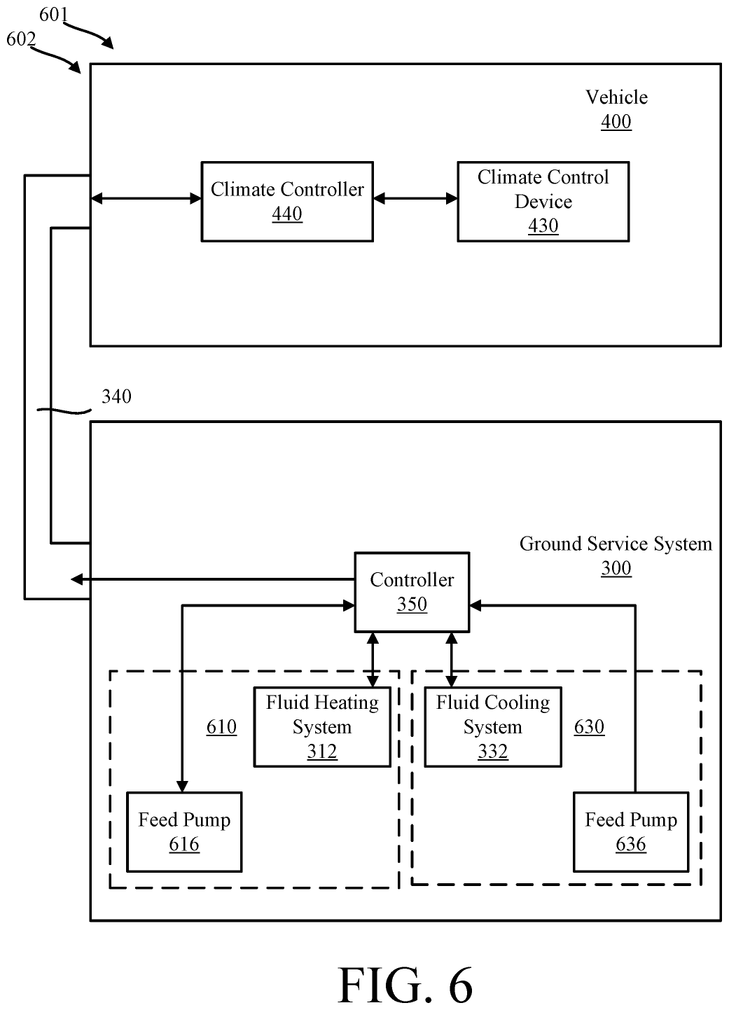

Referring now to FIG. 6, a schematic view for a control system 602 of a climate control system 601 for an electric vehicle (e.g., vehicle 400) is illustrated, in accordance with various embodiments. Control system 602 includes the controller 350, the climate heating system 610, and the climate cooling system 630 of ground service system 300 and a climate controller 440 and the climate control device 430 of the vehicle 400 in various electrical communication.

Climate controller 440 may comprise at least one computing device in the form of a computer or processor, or a set of computers/processors, although other types of computing units or systems may be used. In various embodiments, climate controller 440 may be implemented as and may include one or more processors and/or one or more tangible, non-transitory memories and be capable of implementing logic. Each processor may be a general purpose processor, a DSP, an ASIC, a FPGA or other programmable logic device, discrete gate or transistor logic, discrete hardware components, or any combination thereof. Climate controller 440 may comprise a processor configured to implement various logical operations in response to execution of instructions, for example, instructions stored on a non-transitory, tangible, computer-readable medium configured to communicate with climate controller 440. In various embodiments, climate controller 440 may be integrated into computer systems onboard an electric vehicle (e.g., vehicle 400), such as, for example a battery control system. In various embodiments, climate controller 440 may be integrated with sensors.

Controller 350 may be in electrical communication with the feed pump 616 and the fluid heating system 312 of climate heating system 610, the fluid cooling system 332, and the feed pump 636 of climate cooling system 630, and the climate controller 440. The climate controller 440 may be in electrical communication with the climate control device 430 and the controller 350. The climate controller 440 may be configured to control and/or monitor the climate control device 430 during fast charging of the battery module 410 from FIG. 2 (e.g., step 106 of method 100). In this regard, the climate controller 440 may monitor when a temperature in a cabin of an aircraft or the like during ground maintenance of the electric vehicle (e.g., vehicle 400), and instruct the controller 350 to either provide hot fluid from the hot tank 314 from FIG. 5 or provide cold fluid form the cold tank 334 from FIG. 5 in response to monitoring the temperature of the cabin.

In various embodiments, the electrical connections between the climate controller 440 and the controller 350 may be routed through the fluid conduit 340 and electrically isolated from any fluid traveling through the fluid conduit 340. In this regard, by coupling fluid conduit 340 to vehicle 400, the climate controller 440 may be electrically coupled to the controller 350 of the ground service system 300, and the climate control device 430 may be fluidly coupled to the plumbing system 601. As such, the fluid conduit 340 may perform various functions (e.g., routing heated and cooled fluid to the battery module 410 from FIG. 3 for heating and cooling in steps 104 and 108 of method 100, routing heated and cooled fluid to the climate control device 430, and electrically coupling the controller to the BMU 420 from FIG. 3 and the climate controller 440 of the vehicle 400).

In various embodiments, numerous improvements of the systems described herein may be readily apparent to one skilled in the art. For example, in accordance with various embodiments, the vehicle may include a pump configured to circulate coolant within the climate control device 430 or the battery module 410 from FIG. 3. Additionally, a pneumatic system may be added to the vehicle 400 to drain coolant from the battery module 410 from FIG. 3 prior to operating the vehicle 400. In various embodiments, a hot charging system, as disclosed herein may eliminate a charge receiving contactor from the vehicle 400.

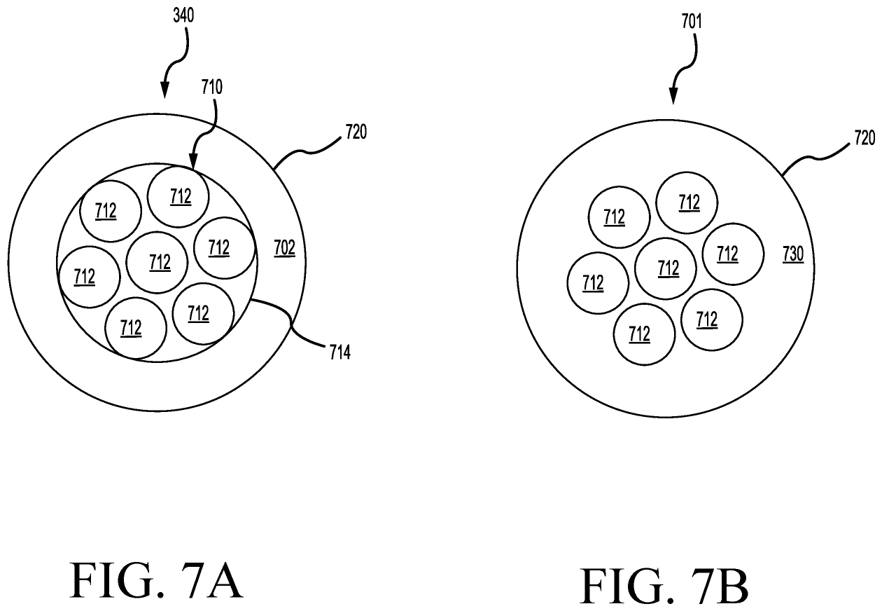

Referring now to FIG. 7A, a fluid conduit 340 from FIGS. 2-3 and 5-6 is illustrated along a cross-sectional view, in accordance with various embodiments. The fluid conduit may comprise a wiring harness 710 and a conduit 720. The wiring harness 710 may be disposed within the conduit 720. The wiring harness 710 may include a plurality of wires 712 and a housing 714. The plurality of wires 712 are disposed within the housing 714. In various embodiments, a flow path 702 may be defined by the housing 714 and the conduit 720. In various embodiments, the plurality of wires are fluidly isolated from the flow path 702. In this regard a fluid may travel through flow path 702 and the plurality of wires 712 may remain isolated. In various embodiments, the fluid conduit 340 may be configured to electrically and fluidly couple the ground service system (e.g., ground service system 300 from FIGS. 2-3 and 5-6) to the vehicle 400 from FIGS. 2-3 and 5-6.

Referring now to FIG. 7B, a fluid conduit 701 for use in a heating system/cooling system utilizing air as a heat transfer fluid is illustrated along a cross-sectional view, in accordance with various embodiments. In various embodiments, the fluid conduit 701 comprises a conduit 720 and a plurality of wires 712 disposed within the conduit. The conduit 720 defines a flow path 730. In various embodiments, the flow path 730 may allow air to flow through the conduit 720 and contact the wires. In this regard, fluid conduit 701 may provide for a simpler design relative to fluid conduit 340 from FIGS. 2-3 and 5-6. In various embodiments, air may be cooled to a lower temperature relative to water and/or may provide a safer hot charging system. For example, air may be cooled to approximately −30° C. Additionally, an air heating/cooling system may rapidly heat or cool ambient air and/or eliminate a hot tank/cold tank from ground service system 300 in FIGS. 2-3 and 5-6.

Although illustrated as comprising a single flow path 702, 730, the present disclosure is not limited in this regard. For example, the fluid conduit 340, 701 may comprise a second flow path (e.g., a return flow path) disposed radially outward from the flow path 702, 730 (e.g., a double walled fluid conduit) or adjacent to the flow path 702, 730, in accordance with various embodiments.

While the principles of this disclosure have been shown in various embodiments, many modifications of structure, arrangements, proportions, elements, materials and components (which are particularly adapted for specific environment and operating requirements) may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments.

However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and C” is used in the claims or specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

We claim:

1. A method of fast charging a battery module, the method comprising:
heating, via a battery heating system, the battery module to a first temperature range;
charging, via a charging system, the battery module while the battery module is heated within the first temperature range; and subsequently
actively cooling, via a battery cooling system, the battery module to a temperature below the first temperature range.

2. The method of claim 1, wherein heating the battery module further comprises pumping a first fluid through the battery module via the battery heating system.

3. The method of claim 2, wherein cooling the battery module further comprises pumping a second fluid through the battery module via the battery cooling system.

4. The method of claim 3, wherein the first fluid is routed through a fluid conduit in fluid communication with the battery module, and wherein the second fluid is routed through the fluid conduit in fluid communication with the battery module.

5. The method of claim 4, wherein the charging system comprises a charger in electrical communication with the battery module via electrical wires, and wherein the electrical wires are routed through the fluid conduit.

6. The method of claim 3, wherein the first fluid is between 40° C. and 100° C. during heating the battery module, and wherein the second fluid is between −10° C. and 20° C. during cooling the battery module.

7. The method of claim 1, further comprising, monitoring, via a battery management system, a state of charge of the battery module during charging the battery module.

8. A hot charging system for use on an electric vehicle, the hot charging system comprising:
a battery heating system configured for fluid communication with a battery module of the electric vehicle;
a battery cooling system configured for fluid communication with the battery module of the electric vehicle;
a charger configured for electrical communication with the battery module of the electric vehicle;
a controller in electric communication with the battery heating system and the battery cooling system; and
a fluid conduit configured to removably couple to the electric vehicle, the fluid conduit comprising electrical wires therein, the fluid conduit configured to receive a first fluid from the battery heating system, the fluid conduit configured to receive a second fluid from the battery cooling system.

9. The hot charging system of claim 8, wherein the battery heating system comprises a hot tank and a first feed pump, and wherein the battery cooling system comprises a cold tank and a second feed pump.

10. The hot charging system of claim 9, wherein the first feed pump is configured to pump fluid from the hot tank through the fluid conduit to heat the battery module during charging of the battery module.

11. The hot charging system of claim 10, further comprising a climate control system including a third feed pump and a fourth feed pump, the third feed pump in fluid communication with the hot tank, the fourth feed pump in fluid communication with the cold tank.

12. The hot charging system of claim 11, wherein the climate control system is configured to pump fluid to a climate control device of the electric vehicle through the fluid conduit.

13. The hot charging system of claim 8, wherein the controller is operable to:
command the battery heating system to pump the first fluid through the fluid conduit to heat the battery module;
command the charger to charge the battery module; and
command the battery cooling system to pump the second fluid through the fluid conduit to cool the battery module.

14. The hot charging system of claim 13, wherein the controller is further operable to:
command a fluid heating system of the battery heating system to heat the first fluid prior to pumping the first fluid; and
command a cooling system of the battery cooling system to cool the second fluid prior to pumping the second fluid.

15. An article of manufacture including a tangible, non-transitory computer-readable storage medium having instructions stored thereon that, in response to execution by a processor, cause the processor to perform operations comprising:
commanding, by the processor, a first feed pump to pump a first fluid through a battery module, the first fluid being heated to a first temperature between 40° C. and 100° C.;
commanding, by the processor, a charger to charge the battery module; and
commanding, by the processor, a second feed pump to pump a second fluid through the battery module, the second fluid having a second temperature less than the first fluid.

16. The article of manufacture of claim 15, wherein the operations further comprise:
commanding, by the processor, a fluid heating system to heat the first fluid to the first temperature prior to pumping the first fluid; and
commanding, by the processor, a cooling system to cool the second fluid to the second temperature prior to pumping the second fluid.

17. The article of manufacture of claim 15, wherein the operations further comprise receiving, by the processor, a state of charge of the battery module while the battery module is charging.

18. The article of manufacture of claim 15, wherein the first feed pump pumps the first fluid through a fluid conduit disposed between a ground service system and a vehicle with the battery module.

19. The article of manufacture of claim 18, wherein the second feed pump pumps the second fluid through the fluid conduit when the second fluid is being pumped through the battery module.

20. The article of manufacture of claim 15, wherein the operations further comprise commanding, by the processor, the charger to stop charging in response to the battery module reaching a predetermined state of charge; and subsequently commanding the second feed pump to pump the second fluid.
